(19) United States
(12) Patent Application Publication
(10) Pub. No.: US 2010/0231098 A1
(43) Pub. Date: Sep. 16, 2010

(54) ELECTRIC MACHINE COMPRISING AN ELASTIC CONNECTION TO A GEARBOX PRIMARY SHAFT

(75) Inventors: Alain Paumier, Maintenon (FR); Etienne Ackermann, Boulogne Billancourt (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES S.A., Velizy Villacoublay (FR)

(21) Appl. No.: 12/738,309

(22) PCT Filed: Oct. 20, 2008
(86) PCT No.: PCT/FR08/51886

§ 371 Date: Apr. 16, 2010

(30) Foreign Application Priority Data
Oct. 19, 2007 (FR) 0758437

(51) Int. Cl. H02K 7/10

(52) U.S. Cl. 310/75 D

(57) ABSTRACT

The present invention relates to an electric machine comprising a rotor (18) able to be coupled to a primary shaft (10) of a gearbox (12) comprising a housing, the said electric machine (16) comprising a stator (20) able to be attached to the housing of the said gearbox, the stator (20) comprising a bearing (32) for centring the said rotor (18), such that the rotor (18) comprises a hub (44) and a body (36): the hub (44), being able to be connected to the primary shaft (10), and comprising external driving teeth (54); the body (36) comprising internal driving teeth (64) collaborating, with lash, with the driving teeth (54) of the hub (44); an elastomeric joint (80) being overmoulded into this lash space to define an elastic connection between the hub (44) and the body (36).

The present invention relates to an electric machine comprising a rotor able to be coupled to an input shaft of a gearbox through an elastic connection. This electric machine is axially positioned between a clutch and the gearbox.

Manual gearboxes in motor vehicles have an input shaft connected to the engine by a clutch, and parallel shafts connected to the drive wheels of the vehicle. The input shaft and the parallel shafts can be connected to one another by pairs of pinions transmitting the movement from one to the other using various gear reduction ratios to obtain transmission ratios.

One of the pinions in each pair is integral with one of the shafts; the other pinion of the pair, freely rotatable on the other shaft, can be made integral with its shaft by axially sliding a synchronizing sleeve. This sliding causes the speeds of the two elements to synchronize via a synchronization device comprising friction cones, and then makes the pinion engage on the shaft.

These manual gearboxes can be robotized, with the control movements carried out by computer-controlled actuators.

A known type of hybrid vehicle, shown in document EP-A1-1331126 in particular, comprises an electric machine disposed downstream from a gearbox input clutch, the rotor being rotationally connected with the input shaft of the gearbox. By allowing the electric machine to rotate independently of the heat engine, with the clutch open, this arrangement has advantages. In particular, it makes it possible to operate in electric drive only, or to recover more energy during braking, as the heat engine remains off and is not braking the vehicle. In addition, this arrangement makes it possible to supply additional energy to help synchronize the speeds of the gearbox input and output shafts.

The electric machine stator is fixed on the gearbox housing, the rotor is centered by bearings secured in a bore connected to the stator, which ensures good concentricity between these two elements and a smaller gap, obtaining higher performance for the electric machine.

This document additionally describes a connection between the rotor of the electric machine and the gearbox input shaft, comprising a torsional spring damper that ensures drive with angular elasticity to filter rotational vibrations of the heat engine. In addition, this torsional damper is responsible for decoupling the connection between the input shaft and the rotor, which can compensate for misalignment.

In the case where the rotor is directly driven, with no torsional damper, this decoupling is not available. A main disadvantage of this arrangement is that between a) the electric machine rotor centered by the stator fixed to the gearbox housing and b) the input shaft of this gearbox, geometry defects may be found in concentricity, or in parallelism between shafts that have an angular displacement, thereby putting a radial load on the electric machine and the bearings supporting the input shaft.

These defects can result from parts manufacturing deviations, assembly conditions, or deformations generated during operation due to the forces being applied to the system.

During operation these defects generate alternating stresses on the various connections, particularly on centering or on the drive splines of the gearbox input shaft, which can cause material erosion of the kind known as “fretting corrosion”, from repeated micro-movements of the splined connection.

Various known devices are attempting to improve this connection, but on the whole they remain complicated, cumbersome, and costly. A particular purpose of the present invention is to eliminate these drawbacks of prior art, and to propose a connection between an electric machine rotor and an input shaft that is simple and efficient, using fewer parts.

To this end, the invention proposes an electric machine comprising a rotor able to be coupled to an input shaft of a gearbox comprising a housing, said electric machine comprising a stator able to be fixed on the housing of said gearbox, the stator comprising a bearing centering said rotor, and the rotor comprising a hub and a body such that:

the hub is connectable to the input shaft and comprises external drive teeth,

the body comprises internal drive teeth cooperating, with some clearance, with the drive teeth of the hub,

an elastomer seal is overmolded into this clearance to form an elastic connection between the hub and the body.

An essential advantage of this elastic drive connection is that it can be implemented simply and economically, using few components. This elastic connection, provided by the elastomer seal filling in the clearance between the hub and the rotor support, is a simple answer to the problem of angular displacement between the rotation axis of the gearbox input shaft (in the engaged position or not) and the rotation axis of the above-described rotor. The dimensions of and material for the elastomer seal are such that said seal ensures torque transmission between both the internal and external teeth clearance.

The drive connection according to the invention can additionally comprise one or more of the following characteristics, which can be combined with one another.

According to a characteristic of the invention, the clearance is substantially constant along the profile of the teeth.

Advantageously, the hub comprises a substantially flat transverse flange, with the external drive teeth on its outer perimeter.

The external drive teeth can cover the entire thickness of the flange and have a contour produced according to an axial generating line.

The hub can comprise a bore axially at the end of the internal splines, for centering the hub on the input shaft

According to another characteristic of the invention, the rotor support is formed by stamping a metal sheet or forging or mechanical welding or casting.

The rotor support can comprise a central cylindrical shape ensuring that the bearings are centered on its outer face and comprising the internal drive teeth on its inner face.

According to an embodiment, the electric machine is axially placed between a clutch and a gearbox.

The hub can comprise axial drill holes that receive sliding clutch operating rods parallel to the shaft.

The invention will be more easily understood, and other characteristics and advantages will become clear in the following description, given as an example, with reference to the attached drawings, in which:

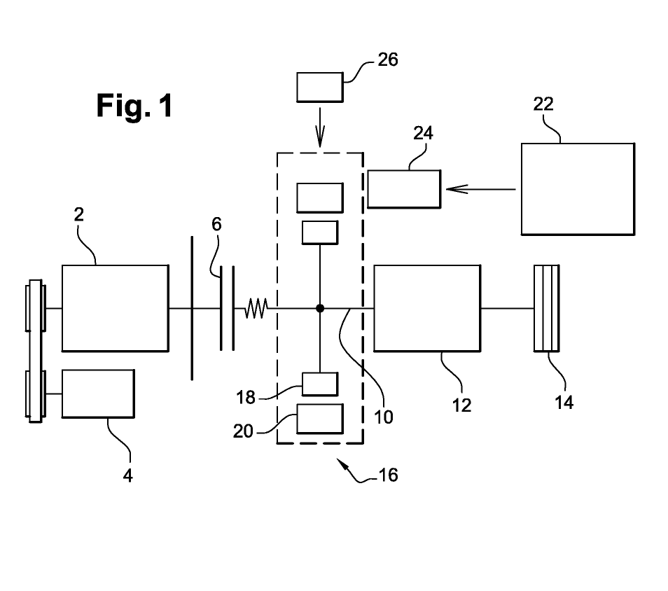

FIG. 1 shows a diagram of a hybrid vehicle drive train comprising an electric machine connected to the gearbox input shaft;

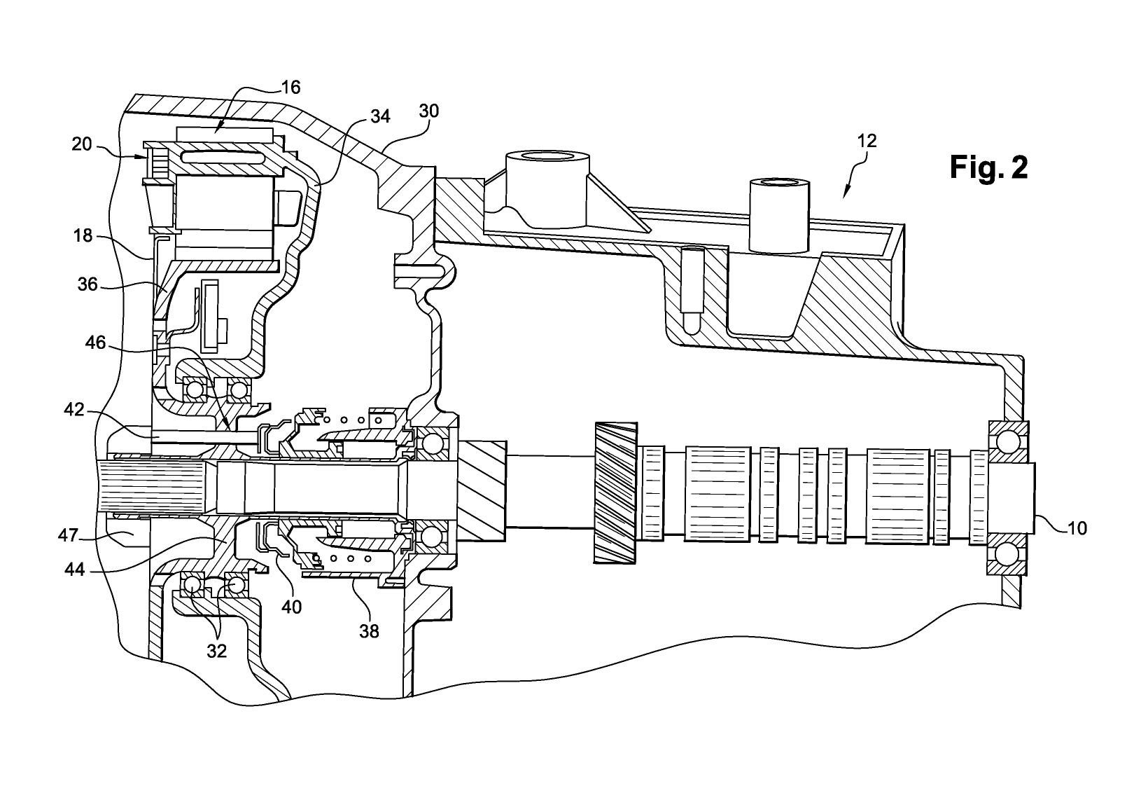

FIG. 2 shows a partial view in axial cross section along the input shaft of a gearbox comprising an electric machine driven by the input shaft; and

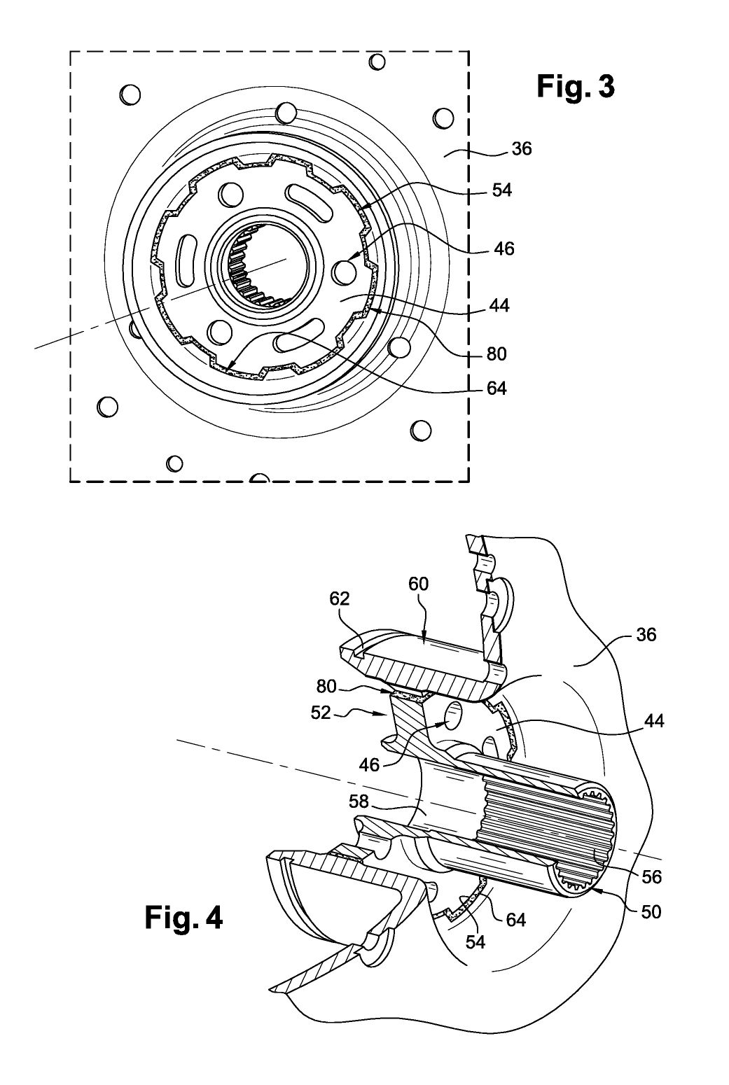

FIGS. 3 and 4 show, in perspective, a drive connection according to the invention.

FIG. 1 shows the drive train of a hybrid vehicle, comprising a heat engine 2 connected to an alternator 4, the heat engine crankshaft driving a main input shaft 10 of a gearbox 12 through a clutch 6, transmitting motion to the vehicle drive wheels 14 according to various gear reduction ratios.

An electric machine 16 that can operate as a motor or as a current generator comprises a rotor 18 connected to the input shaft 10 of the gearbox 12, and a stator 20 fixed to the housing of said gearbox. The electric machine 16 connected to an electric capacitor or battery 22 through an inverter 24, which are controlled by a computer 26 that takes into account various operating parameters of the vehicle, as well as the driver's request, to provide an electrical charging current to the capacitor or an engine torque, in order to optimize the vehicle's overall energy consumption.

The gearbox can be a robotized box, comprising an electronic computer that controls clutch and gearshift actuators, for implementing completely automatic operation.

FIG. 2 shows a gearbox 12 whose input shaft 10 is connected on the engine end, or front end, to a clutch not shown, and on the back end through splines to pinions that belong to pinion pairs yielding various transmission ratios. The gearbox housing has a clutch housing 30 at the front side.

An electric machine 16 with reduced axial dimension and centered on the input shaft 10 is placed in the clutch housing 30 between the clutch and the gearbox 12.

This electric machine 16 comprises a stator 20 fixed in the clutch housing 30, and a rotor 18 rotationally connected to the input shaft 10. The stator 20, located radially on the outside, comprises a support 34 comprising a substantially flat transverse part whose center forms a cylindrical part that comes radially above the outer races of two ball bearings 32, centered on the input shaft, 10 to support them.

Likewise, the rotor 18 comprises a support 36 comprising a substantially flat transverse part whose center forms a cylindrical part that comes radially below the ball bearings 32, to support their inner races.

With the ball bearings 32 thusly ensuring direct centering between the rotor 18 and the stator 20, one can have a reduced clearance gap between these two elements, which improves the efficiency of the electric machine.

The clutch coupling system comprises a control device comprising a concentric hydraulic cylinder 38, located between the electric machine 16 and the gearbox 12, whose sleeve and axially sliding piston comprise an axial passage that receives the input shaft 10. The piston of the hydraulic cylinder 38 transmits its motion to the clutch 6 through a ball thrust bearing 40 that presses on three axially sliding rods 42 parallel to the shaft and equally distributed around the input shaft 10.

The sliding rods 42 go through a hub 44 of the rotor 18, which rotationally connects the rotor support 36 to the input shaft 10, said rods sliding in axial drill holes 46 of this hub, which guide them. Next, the sliding rods 42 press on a second ball thrust bearing 47, which is in direct contact with the clutch.

In this way, one can transmit an axial movement of the piston of the hydraulic cylinder 38, which is fixed, to a clutch rotationally connected to the heat engine crankshaft, through the rotor hub 44, which is rotationally connected to the input shaft 10 and can rotate at a different speed than the clutch.

FIGS. 3 and 4 show details of the hub 44 and its connection with the rotor 18. The hub 44 comprises an axially elongated central part 50 comprising internal splines 56 in mesh with corresponding splines on the input shaft. At the end of the internal splines 56 and at the back, the central part 50 comprises a bore 58 that ensures that the hub 44 is centered on a corresponding cylindrical part of the input shaft 10.

This way, one can have precision guidance between the hub 44 and the input shaft 10, and rotational drive that allows axial sliding.

The hub 44 additionally comprises a flat transverse flange 52, comprising the axial drill holes 46 that receive the sliding rods 42, and on its outer perimeter, external drive teeth 54 extending axially over the thickness of the flange and contoured according to an axial generating line.

The support 36 of the rotor 18 receives the inner rings of two bearings 32 on an axially extending central cylindrical shape 60, and holds them in place with an open ring that fits into an outer circular groove 62 in said cylindrical shape.

The central cylindrical shape 60 comprises internal teeth 64 in mesh with the external teeth 54 on the outside perimeter of the flat transverse flange 52. A substantially constant clearance is provided along the contour between the internal and external teeth for receiving an elastomer seal 80.

The elastomer seal 80 is overmolded in the tooth clearance, to connect the two parts to one another in a flexible manner. This elastomer seal 80 makes it possible to transmit a torque from the rotor 18 of the electric machine 16 to the input shaft 10, due to meshing of the teeth, while allowing a small angular displacement as well as off-center movement between the hub 44, guided by the input shaft 10, and the rotor 36.

The material for the elastomer is chosen to withstand alternating stresses and operating conditions like temperature, and it must also adhere well to the two parts being connected.

When using a rotor connected to the clutch housing 30 through bearings 32, the possible angular displacement and off-center movement of the hub 44 can compensate for relative misalignments of the input shaft 10 with the gearbox 12 without generating significant stresses on the connections, in particular the bearings 32, the internal splines 56, and the bore 58 in the hub 44, protecting them from premature deterioration.

Moreover, the drive connection with intermeshing teeth (and particularly the stiffness of the elastomer seal 80) ensures low angular elasticity in a transverse plane between the rotor 18 and the input shaft 10, which makes it possible to maintain good rotational synchronization of these two components and to not interfere with the operational features of the electric machine.

This connection is simple and economical. With its central cylindrical shape 60, the rotor 18 support 36 can easily be made by one of the following processes: sheet metal stamping, forging, mechanical welding, or casting.

The internal 64 and external 54 teeth do not require great precision for their contours, the clearance being entirely filled by the elastomer. The hub 44 can for example be made of metal sintered by compressing powder in a mold so as to obtain all the finished shapes directly by moulding.

In addition, the connection is compact. Using a single layer of sheet metal to make the central cylindrical shape 60 of the rotor 18 support, by centering the bearings 32 on an outside face, and the internal teeth 54 on the inside face, this makes a radially compact assembly, which in particular makes it possible to reduce the diameter of the bearings 32.

1. Electric machine comprising:
a rotor able to be coupled to an input shaft of a gearbox comprising a housing,
a stator able to be fixed on the housing of said gearbox, the stator comprising a bearing centering said rotor,
wherein the rotor comprises a hub and a body:
the hub being connectable to the input shaft and comprising external drive teeth,
the body comprising internal drive teeth cooperating, with some clearance, with the drive teeth of the hub,
an elastomer seal being overmolded into this clearance to form an elastic connection between the hub and the body.

2. Electric machine according to claim 1, wherein the clearance between the external drive teeth and the internal drive teeth is substantially constant along the profile of the teeth.

3. Electric machine according to claim 1, wherein the hub comprises a substantially flat transverse flange, with the external drive teeth on its outer perimeter.

4. Electric machine according to claim 3, wherein the external drive teeth cover the entire thickness of the flange, and have a contour produced according to an axial generating line.

5. Electric machine according to claim 1, wherein the hub comprises a bore axially at the end of the internal splines, for centering the hub on the input shaft.

6. Electric machine according to claim 1, wherein the rotor support is formed by stamping a metal sheet or forging or mechanical welding or casting.

7. Electric machine according to claim 1, wherein the rotor support comprises a central cylindrical shape ensuring that the bearings are centered on its outer face and comprising the internal drive teeth on its inner face.

8. Electric machine according to claim 1, wherein the electric machine is axially positioned between a clutch and the gearbox.

9. Electric machine according to claim 8, wherein the hub comprises axial drill holes (46) able to receive sliding clutch operating rods parallel to the shaft.

10. Electric machine according to claim 2, wherein the hub comprises a substantially flat transverse flange, with the external drive teeth on its outer perimeter.

11. Electric machine according to claim 10, wherein the external drive teeth cover the entire thickness of the flange, and have a contour produced according to an axial generating line.

12. Electric machine according to claim 2, wherein the hub comprises a bore axially at the end of the internal splines, for centering the hub on the input shaft.

13. Electric machine according to claim 2, wherein the rotor support is formed by stamping a metal sheet or forging or mechanical welding or casting.

14. Electric machine according to claim 2, wherein the rotor support comprises a central cylindrical shape ensuring that the bearings are centered on its outer face and comprising the internal drive teeth on its inner face.

15. Electric machine according to claim 2, wherein the electric machine is axially positioned between a clutch and the gearbox.

16. Electric machine according to claim 15, wherein the hub comprises axial drill holes able to receive sliding clutch operating rods parallel to the shaft.

17. Electric machine according to claim 3, wherein the hub comprises a bore axially at the end of the internal splines, for centering the hub on the input shaft.

18. Electric machine according to claim 3, wherein the rotor support is formed by stamping a metal sheet or forging or mechanical welding or casting.

19. Electric machine according to claim 3, wherein the rotor support comprises a central cylindrical shape ensuring that the bearings are centered on its outer face and comprising the internal drive teeth on its inner face.

20. Electric machine according to claim 3, wherein the electric machine is axially positioned between a clutch and the gearbox.
